(19) United States
(12) Patent Application Publication
(10) Pub. No.: US 2012/0028056 A1
(43) Pub. Date: Feb. 2, 2012

(54) METHOD FOR FABRICATING A THERMAL BARRIER COVERING A SUPERALLOY METAL SUBSTRATE, AND A THERMOMECHANICAL PART RESULTING FROM THIS FABRICATION METHOD

(75) Inventors: Yannick Cadoret, Maurepas (FR); Samuel Hervier, Migne-Auxances (FR); Claude Mons, Savigny Le Temple (FR); Annie Pasquet, Longjumeau (FR)

(73) Assignee: SNECMA, Paris (FR)

(21) Appl. No.: 13/148,598

(22) PCT Filed: Feb. 5, 2010
(86) PCT No.: PCT/FR2010/050189

§ 371 Date: Oct. 18, 2011

(30) Foreign Application Priority Data
Feb. 10, 2009 (FR) 0900570

(51) Int. Cl. B32B 15/04; B24B 1/00

(52) U.S. Cl. 428/457; 451/28

(57) ABSTRACT

A fabrication method of fabricating a thermal barrier covering a superalloy metal substrate, the thermal barrier including at least an underlayer and a ceramic layer, the method including: smoothing a surface state of the underlayer by at least one physicochemical and/or mechanical process prior to depositing the ceramic layer such that a number of defects presenting a peak-to-peak difference lower than or equal to 2 μm is at most five over any distance of 50 μm, and then depositing the ceramic layer. The method can be applied to turbine blades.

The invention relates to a method of fabricating or repairing a thermal barrier covering a superalloy metal substrate, and also to the thermomechanical part that results from this fabrication method.

The search for increasing efficiency in turbomachines, in particular in the field of aviation, and the search for reducing fuel consumption and polluting emissions of gas and combustion residues have led to getting closer to stoichiometric combustion of fuel. This situation is accompanied by an increase in the temperature of the gas leaving the combustion chamber and flowing towards the turbine.

Nowadays, the limiting temperature of use for superalloys is about 1100° C., while the temperature of the gas leaving the combustion chamber or entering the turbine may be as high as 1600° C.

Consequently, it has been necessary to adapt the materials of the turbine to this high temperature by improving techniques for cooling the blades of turbines (hollow blades) and/or by improving the abilities of these materials to withstand high temperatures. This second approach, in combination with the use of superalloys based on nickel and/or cobalt, has led to several solutions including depositing a thermally insulating coating on the superalloy substrate, which coating is referred to as a thermal barrier and is made up of a plurality of layers.

The use of thermal barriers in aeroengines has become widespread over the past twenty years and enables the temperature of the gas admitted into turbines to be increased, enables the flow of cooling air to be reduced, and thus enables engine efficiency to be improved.

The insulating coating serves to create a temperature gradient through the coating on a part that is cooled under continuous operating conditions, and the total amplitude of the gradient may exceed 100° C. for a coating having a thickness of about 150 micrometers (μm) to 200 μm and presenting thermal conductivity of 1.1 watts per meter and per kelvin (W·m⁻¹·K⁻¹). The operating temperature of the underlying metal forming the substrate for the coating is reduced by the same gradient, thereby leading to large savings in the volume of cooling air that is needed, in the lifetime of the part, and in the specific consumption of the turbine engine.

It is known to have recourse to using a thermal barrier including a ceramic layer based on zirconia stabilized with yttrium oxide and presenting a coefficient of expansion that is different from that of the superalloy constituting the substrate, together with thermal conductivity that is quite low. Stabilized zirconia may also sometimes contain at least one oxide of an element selected from the group constituted by the rare earths, and preferably from the subgroup constituted by: Y (yttrium); Dy (dysprosium); Er (erbium); Eu (europium); Gd (gadolinium); Sm (samarium); Yb (ytterbium); or a combination of an oxide of Ta (tantalum) and at least one rare earth oxide; or with a combination of an oxide of Nb (niobium) and at least one rare earth oxide.

In order to anchor this ceramic layer, a metallic underlayer having a coefficient of expansion close to that of the substrate is generally interposed between the substrate of the part and the ceramic layer. This underlayer provides adhesion between the substrate of the part and the ceramic layer, it being understood that the adhesion between the underlayer and the substrate of the part is provided by interdiffusion, and that the adhesion between the underlayer and the ceramic layer is provided by mechanical anchoring and by the propensity of the underlayer to develop, at high temperature and at the ceramic/underlayer interface, a thin layer of oxide that provides chemical contact with the ceramic. In addition, this metal underlayer protects the part against corrosion phenomena.

Amongst the coatings used, mention is made of the quite widespread use of a layer of ceramic based on zirconia that is partially stabilized with yttrium oxide, e.g. Zr_{0.92}Y_{0.08}O_{1.96}.

In particular, in known methods (air plasma spray, very low pressure plasma spray), it is known to make use of an underlayer formed of an alloy of the MCrAlY type, where M is a metal selected from nickel, cobalt, iron, or a mixture of these metals, and that constitutes a gamma-gamma prime matrix of nickel cobalt with, in solution therein, chromium containing NiAl β precipitates.

It is also known to make use of an underlayer, e.g. constituted by nickel aluminides, that includes a metal selected from platinum, chromium, palladium, ruthenium, iridium, osmium, rhodium, or a mixture of these metals, and/or a reactive element selected from zirconium (Zr), cerium (Ce), lanthanum (La), titanium (Ti), tantalum (Ta), hafnium (Hf), silicon (Si), and yttrium (Y). For example, a coating of the Ni₍₁₋ₓ₎PtₓAl type is used in which the platinum is inserted in the nickel lattice. The platinum is deposited electrolytically before the aluminization thermochemical treatment.

This metal underlayer may also be constituted by a platinum-modified nickel aluminide (Ni, Pt)Al using a method that comprises the following steps: preparing the surface of the part by chemical cleaning and sand blasting; electrolytically depositing a coating of platinum (Pt) on the part; optionally heat treating the result to cause the Pt to diffuse in the part; depositing aluminum (Al) by chemical vapor deposition (CVD) or by physical vapor deposition (PVD); optionally heat treating the result in order to cause Pt and Al to diffuse into the part; preparing the surface of the resulting metal underlayer; and depositing a ceramic coating by electron beam physical vapor deposition (EB-PVD).

Finally, the underlayer may correspond to a coating solely of diffused platinum that consists in a gamma-gamma prime matrix of nickel cobalt with Pt in solution.

In order to obtain a coating and/or the coating underlayer, a step is sometimes also implemented that consists in modifying the surface of the superalloy part by depositing a layer of platinum that is more than 10 μm thick and then in performing diffusion heat treatment.

Thus, the Applicant company makes use of a thermochemical coating known as CIA that is formed by a chromium-modified aluminide coating and that results from successively implementing two vapor deposition steps: a first step of depositing a 2 μm to 6 μm thick layer of chromium, followed by an aluminization step.

Such a coating is used more as a coating for protecting parts from oxidation or high temperature corrosion, or optionally as an underlayer for a thermal barrier.

In traditional manner, the use of a metal underlayer including aluminum generates a layer of alumina Al₂O₃ by natural oxidation in air, which layer covers the entire underlayer.

Usually, the ceramic layer is deposited on the part for coating either by a spray technique (in particular a plasma spray technique), or by physical vapor deposition, i.e. by evaporation (e.g. by electron beam physical vapor deposition (EB-PVD) in which a coating is formed by deposition in an evacuated evaporation enclosure under electron bombardment).

With a sprayed coating, a zirconia-based oxide is deposited by plasma spray type techniques in a controlled atmosphere, thereby leading to the formation of a coating that is constituted by a stack of molten droplets that are quenched by shock, flattened, and stacked so as to build up a deposit that is imperfectly densified to a thickness generally lying in the range 50 μm to 1 millimeter (mm).

A physically-deposited coating, e.g. using evaporation under electron bombardment, gives rise to a coating that is made up of an assembly of small columns that are directed substantially perpendicularly to the surface for coating, over a thickness lying in the range 20 μm to 600 μm. Advantageously, the space between the columns enables the coating to be effective in compensating the thermomechanical stresses that, at operating temperatures, are due to the differential expansion relative to the superalloy substrate.

Thus, parts are obtained having lifetimes that are long in terms of high temperature thermal fatigue.

Conventionally, such thermal barriers thus create a discontinuity in thermal conductivity between the outer coating on the mechanical part, forming the thermal barrier, and the substrate of the coating that forms the material constituting the part.

Usually, it is found that thermal barriers that give rise to a significant discontinuity in thermal conductivity also give rise to a significant risk of delamination between the coating and the substrate, or more precisely at the interface between the underlayer and the ceramic layer. This situation leads to flaking of the ceramic layer, such that the substrate is locally no longer protected by the layer of insulating ceramic, and is subjected to higher temperatures, so it becomes damaged very quickly.

This damage results in part from the phenomenon commonly known as “rumpling” that occurs during cycles involving large variations in the temperature to which the materials are subjected once the engines are put into service, with this applying in particular to turbine blades.

This phenomenon leads to deformation of the underlayer and results from various parameters. Rumpling may be explained by:
the initial surface state that has a major role concerning the adhesion of the ceramic in service;
the difference of the coefficients of expansion between the underlayer and the superalloy, which leads to progressive deformation of the coating during successive cycles at high temperature;
the β-(Ni,Pt)Al→γ′-Ni₃Al phase transformation and interdiffusion phenomenon between the metal substrate and the coating;
the martensitic transformation of the β-(Ni,Pt)Al phase that occurs on cooling at aluminum contents of less than 37% atomic;
growth stresses in the alumina layer; and
the chemical composition of the substrate (effect of reactive elements).

In the literature, it is accepted that the rumpling phenomenon is a degradation mechanism that is inevitable for thermal barrier systems. Thus, the article “Temperature and cycle-time dependence of rumpling in platinum-modified diffusion aluminide coatings” (V. K. Tolpygo and D. R. Clarke, Scripta Materialia 57 (2007), pp. 563-566) shows clearly the effects of temperature, frequency, and duration of thermal cycles, these parameters being significant factors in the progress of the rumpling phenomenon at high temperature. According to the authors, this phenomenon of underlayer deformation is associated directly with temperature and remains inevitable at temperatures higher than 1100° C.

Numerous attempts in the prior art at avoiding or retarding the appearance of the rumpling phenomenon are based on modifying the chemical composition of the superalloy substrate. Thus, the article “Effect of Hf, Y, and C in the underlying superalloy on the rumpling of diffusion aluminide coatings”, by V. K. Tolpygo et al. Acta Materialia, 56 (2008), pp. 489-499, presents the decohesion of the thermal barrier that results from the rumpling phenomenon as being inevitable and observes a modification of the time at which it appears as a function of the content of hafnium and carbon in the superalloy.

In the same manner, Spitsberg et al. in the article “On the failure mechanisms of thermal barrier coatings with diffusion aluminide bond coatings”, Materials Science and Engineering, A 394 (2005), pp. 176-191 show that the use of a substrate enriched in rhenium can modify lifetime in terms of flaking for identical surface treatment. The effect of rhenium appears to modify the time for the rumpling phenomenon to appear, but it cannot be eliminated completely under any circumstances.

An object of the present invention is thus to propose a method of fabricating a thermal barrier and a thermal barrier structure resulting from said method that prevent or retard the appearance of the rumpling phenomenon, or that minimize its magnitude.

Another object of the invention is to provide a superalloy thermomechanical part that results from said fabrication method and that limits damage to the underlayer resulting from the rumpling phenomenon while the part, in particular, a blade, is in operation at high temperature, and to do in such a manner as to increase significantly the flaking lifetime of the thermal barrier system.

To this end, according to the present invention, the fabrication method is characterized in that the following step is implemented: the surface state of the underlayer is smoothed by at least one physicochemical and/or mechanical process prior to depositing the ceramic layer in such a manner that the number of defects presenting a peak-to-peak difference (between the bottom of a valley and the top of a peak) lower than or equal to 2 μm is at most five over any distance (pitch or extent) of 50 μm, and then depositing the ceramic layer.

In this way, it can be understood that the conditions to be satisfied in order to achieve this object correspond to combining the following two conditions:
a surface state of the underlayer that presents controlled roughness with a limited density of “large defects” per unit area; and
the presence of a ceramic layer on the underlayer (directly on the underlayer or with an interposed alumina layer).

With roughness that satisfies the conditions set out in the present patent application, and in the presence of a ceramic layer, the Applicant has found that the rumpling phenomenon is non-existent or in any event greatly limited, even though there used to be a prejudice against being able to escape from the rumpling phenomenon in particular by having recourse to modifying the surface state of the underlayer or to modifying the chemical composition of the underlayer.

The explanations that the Applicant suggests concerning the unexpected performance of thermal barriers obtained by the fabrication method in accordance with the invention lie in particular in the fact that an effect of synergy is obtained: the optimized surface state of the underlayer makes it possible firstly to achieve good adhesion of the ceramic layer, and secondly to limit the number of occurrences of large-amplitude defects (indentations or peaks) both over the surface of the underlayer and over the surface of the ceramic layer, thereby avoiding creating centers for delamination, and indeed the ceramic layer stiffens the thermal barrier and guarantees high-temperature protection for the layers of material situated under it. The presence of the ceramic layer prevents any deformation of the metal underlayer, if and only if the surface state is optimized in compliance with the parameters given below.

Overall, the solution of the present invention makes it possible to increase the lifetime of the thermal barrier and of the part coated with the thermal barrier by inhibiting the rumpling phenomenon while the part is in service.

This solution also presents the additional advantage of being easy to implement and to reproduce.

The solution of the present invention goes against a prejudice relating to the impossibility of avoiding the rumpling phenomenon, and this result is made possible by determining conditions that need to be satisfied for the assembly constituted by the underlayer and the ceramic layer, without being limited to the characteristics of the underlayer alone or of the ceramic alone.

The present invention applies not only when making a thermal barrier for initial fabrication of a thermomechanical part, but also for repairing a thermal barrier. When performing a repair, the method described herein is performed beforehand, the ceramic layer is removed, and optionally the underlayer is removed, and then a new underlayer is deposited.

Under such circumstances, the surface portions that have been repaired in application of the conditions determined by the present invention benefit from increased lifetimes of the thermal barrier recreated in this way.

Such a repair may be found to be necessary on particular wear zones of certain parts, in particular the leading edges and trailing edges of blades in the field of aviation, be they fan blades, compressor blades, and/or turbine blades of a turbine engine.

The invention is preferably applied to thermomechanical parts presenting a nickel-based superalloy substrate, in particular monocrystalline turbine blades that are cooled by air flowing in internal channels.

The invention applies to thermomechanical parts presenting a substrate made of any type of superalloy, in particular one based on nickel and/or on cobalt and/or on Fe.

Concerning the conditions that need to be satisfied for the surface state of the underlayer, the Applicant has found various ways of characterizing them. Thus, one or another or several of the following provisions are applicable:
the physicochemical and/or mechanical process gives rise to a surface state of the underlayer such that the number of defects (indentations or peaks) presenting an amplitude greater than 1 μm relative to the mean position of the top face of the underlayer (mean profile or theoretical surface line) is at most five over any distance (pitch or extent) of 50 μm;
the physicochemical and/or mechanical process gives rise to a surface state of the underlayer such that the roughness Ra of the underlayer lies in the range 0.05 μm to 3 μm, and preferably in the range 0.05 μm to 1 μm, where the roughness Ra is the mean difference: this is the arithmetic mean of the differences relative to the mean line or the integral mean of all of the differences in absolute value;
the physicochemical and/or mechanical process gives rise to a surface state of the underlayer such that the roughness Rz of the underlayer is less than 10 μm, where roughness Rz is regularity: this is the mean of the total differences of roughness “Rt” observed over five lengths, where “Rt” is the total difference that corresponds to the greatest difference in level between the top of the highest peak and the bottom of the deepest indentation;
the physicochemical and/or mechanical process gives rise to a surface state of the underlayer such that at least one of the following criteria is satisfied:

0 μm<Rk<5 μm;

0 μm<Rvk<3 μm;

0 μm<Rpk<3 μm;

−1<Sk<1; and

1<Ek<10;

where the parameters Rk, Rpk, and Rvk are calculated on the basis of an Abott curve, Rk being the depth of the peak-limited profile that represents the depth of the central roughness of the profile, Rvk being the depth of the valleys that are eliminated and represents the mean depth of the valleys exceeding the central portion of the profile, and Rpk being the height of the peaks that have been eliminated and represents the mean height of the peaks exceeding the central portion of the profile, and where Sk corresponds to the symmetry of the amplitude distribution curve and Ek to the overall reference trace.

The physicochemical and/or mechanical process that enables the looked-for surface state to be obtained preferably forms part of the group comprising: dry sand blasting, wet sand blasting, mechanical polishing, electrolytic polishing, and tribofinishing.

For example, “tribofinishing” is used to mean processes that incorporate the techniques of polishing, deburring, deoxidizing, smoothing, degreasing, . . . .

These processes use abrasive media (ceramic, porcelain, plastics, metals), chemical additives, and equipment that generates movement (vibrators, centrifuges, . . . ), in a controlled chemical environment.

The present invention also provides a thermomechanical part obtained by the above-described fabrication method.

In particular, the present invention provides a thermomechanical part made on a superalloy metal substrate and covered in a thermal barrier including at least an underlayer and a ceramic layer, in which one or more of the following provisions have been implemented:
the underlayer is a metal underlayer constituted by nickel aluminide optionally containing a metal selected from platinum, chromium, palladium, ruthenium, iridium, osmium, rhodium, or a mixture of these metals, and/or a reactive element selected from zirconium (Zr), cerium (Ce), lanthanum (La), titanium (Ti), tantalum (Ta), hafnium (Hf), silicon (Si), and yttrium (Y), in particular a metal underlayer constituted of NiAlPt, or or a metal underlayer of the MCrAlY type, where M is a metal selected from nickel, cobalt, iron, or a mixture of these metals, or based on Pt. Finally, the metal underlayer may correspond to a coating of platinum diffused on its own and constituting a gamma-gamma prime matrix of nickel cobalt with platinum (Pt) in solution;
said underlayer is constituted by an alloy suitable for forming a protective layer of alumina by oxidation; and
said ceramic layer is based on stabilized zirconia, i.e. yttrified zirconia presenting a molar content of yttrium oxide lying in the range 4% to 12%. This stabilized zirconia may also sometimes contain at least one oxide of an element selected from the group constituted by the rare earths, and preferably from the subgroup: Y (yttrium); Dy (dysprosium); Er (erbium); Eu (europium); Gd (gadolinium); Sm (samarium); Yb (ytterbium); or a combination of an oxide of Ta (tantalum) and at least one rare earth oxide; or with a combination of an oxide of Nb (niobium) and at least one rare earth oxide.

The present invention also provides a thermomechanical part for a turbomachine, and in particular a combustion chamber, a turbine blade, a turbine distributor, or any thermomechanical part suitable for being coated in a thermal barrier system.

Other advantages and characteristics of the invention appear on reading the following description given by way of example and made with reference to the accompanying drawings, in which:

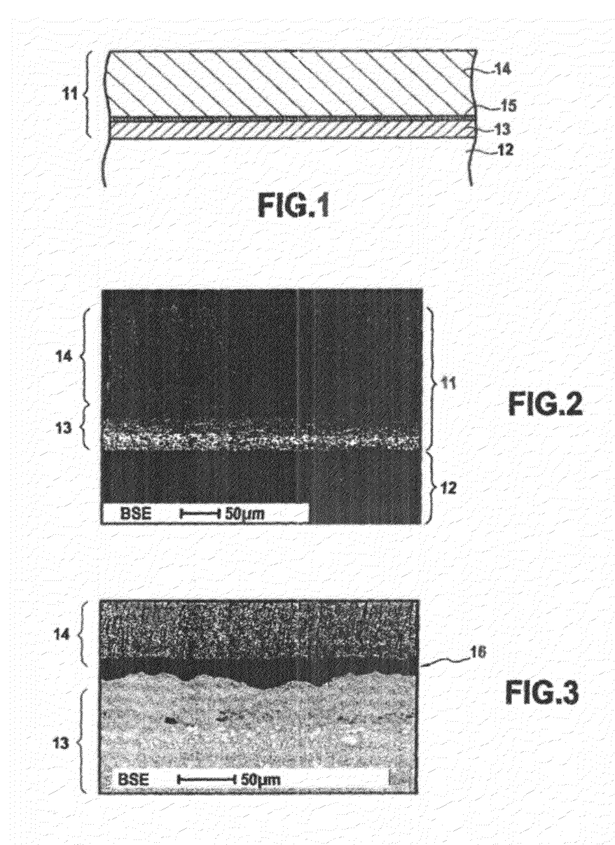

FIG. 1 is a diagrammatic section view showing a portion of a mechanical part coated in a thermal barrier;

FIG. 2 is a micrographic section showing the various layers of the thermal barrier on the surface of the part;

FIG. 3 is a view analogous to FIG. 2 for a part that has suffered damage to the thermal barrier in service;

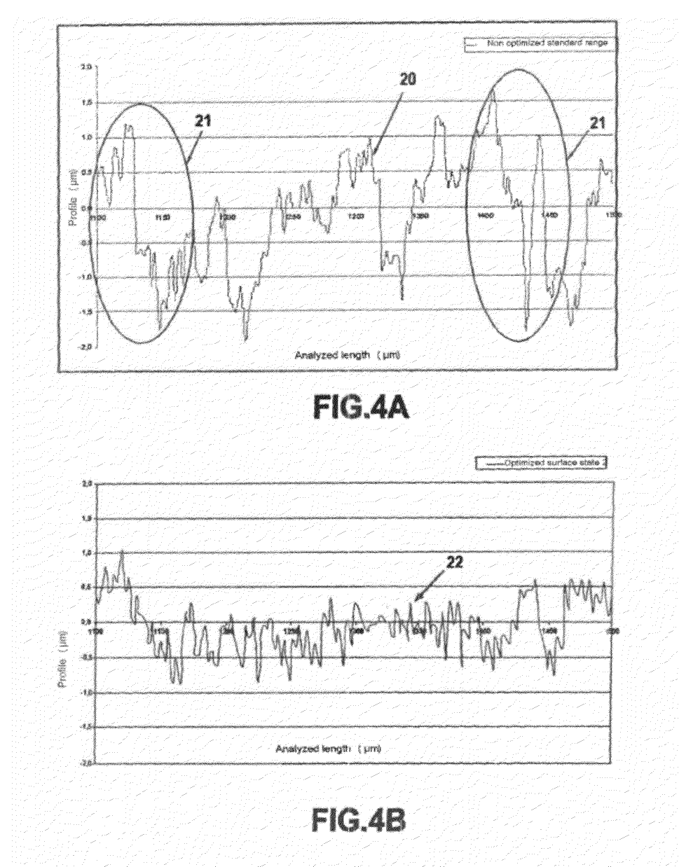

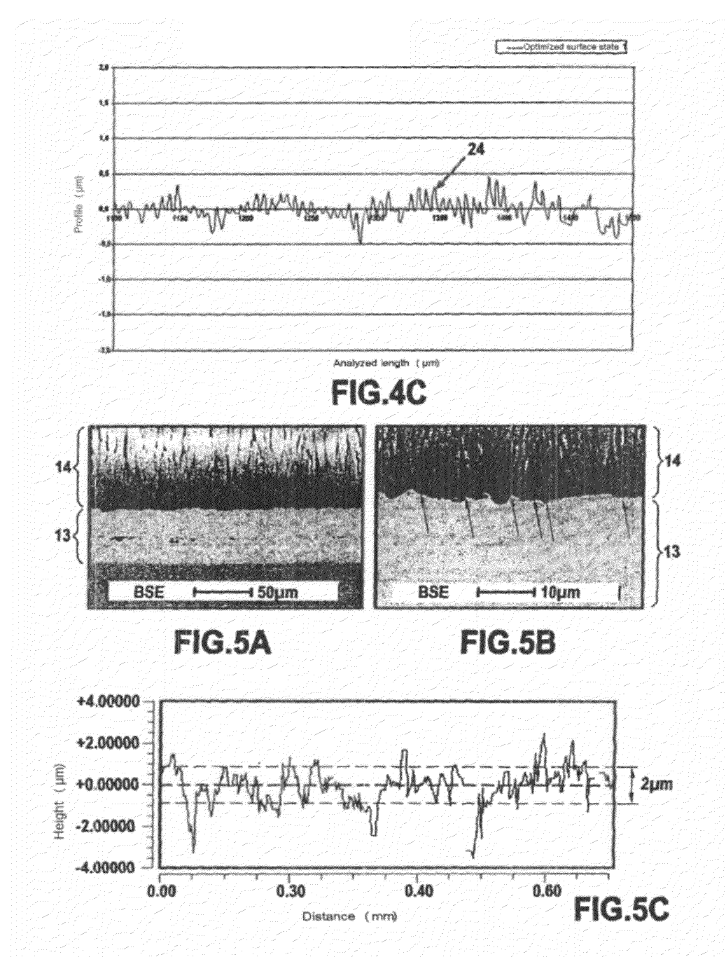

FIGS. 4A, 4B, and 4C show different roughness profiles corresponding to different surface states of the underlayer;

FIGS. 5A and 5B are micrographic sections at different magnifications showing a prior art thermal barrier before service, and FIG. 5C shows the roughness profile of the corresponding surface of the underlayer prior to being put into service;

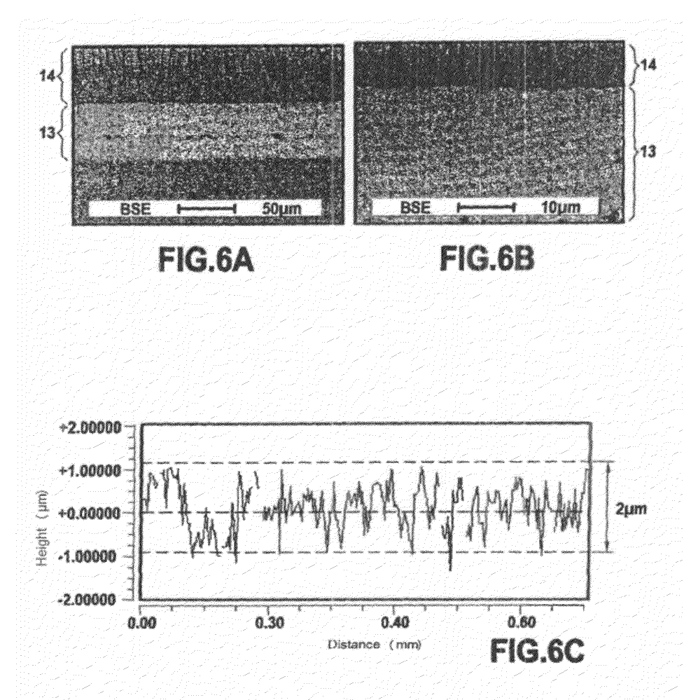

FIGS. 6A, 6B, and 6C are views in the new state, prior to service and at different magnifications, that are similar respectively to the views of FIGS. 5A, 5B, and 5C for a first implementation of the method in accordance with the invention;

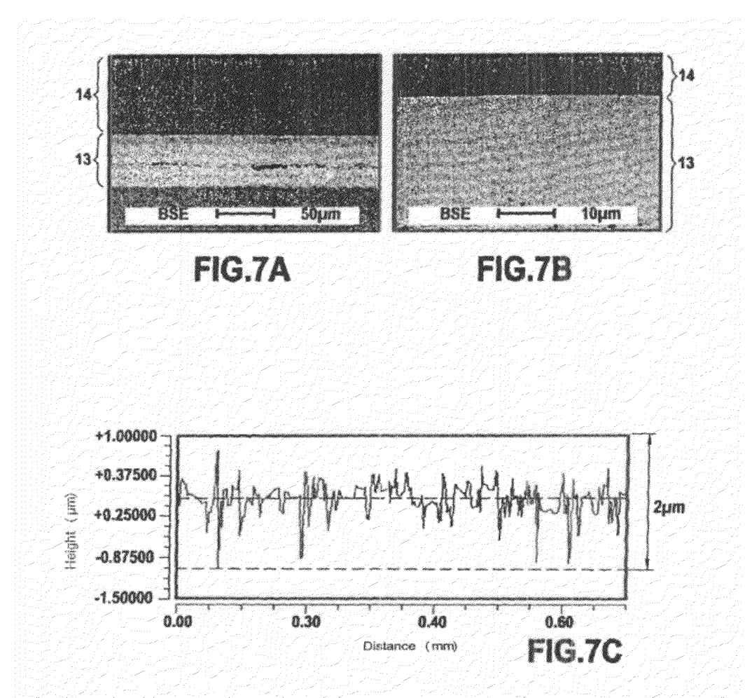

FIGS. 7A, 7B, and 7C are views in the new state, prior to service and at different magnifications, that are similar respectively to the views of FIGS. 5A, 5B, and 5C for a second implementation of the method in accordance with the invention;

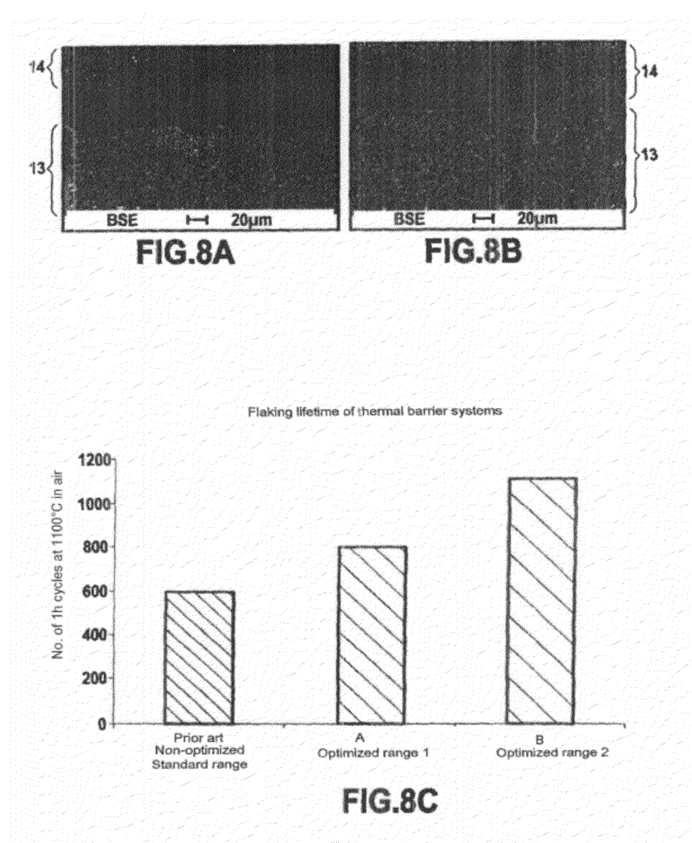

FIGS. 8A and 8B are micrographic sections showing respectively a prior art thermal barrier after service and a thermal barrier that results from the second implementation of the method in accordance with the invention, likewise after service, and FIG. 8C is a chart showing the flaking lifetimes of the various thermal barriers

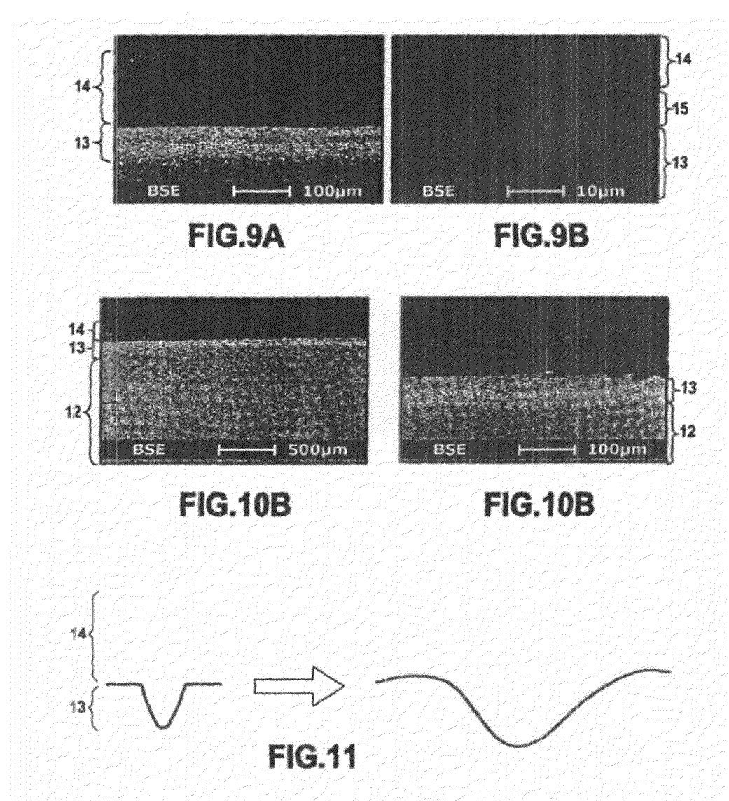

FIGS. 9A and 9B are micrographic sections at different magnifications showing, after service, a thermal barrier resulting from an implementation of the method in accordance with the invention;

FIGS. 10A and 10B are micrographic sections at different magnifications showing an implementation of the method of the invention presenting a zone of the ceramic layer that has flaked; and

FIG. 11 illustrates the rumpling phenomenon.

The mechanical part shown in part in FIG. 1 has a thermal barrier coating 11 deposited on a superalloy substrate 12, such as a superalloy based on nickel and/or cobalt. The thermal barrier coating 11 comprises a metal underlayer 13 deposited on the substrate 12, and a ceramic layer 14 deposited on the underlayer 13.

The bonding underlayer 13 is a metal underlayer constituted by nickel aluminide, optionally containing a metal selected from platinum, chromium, palladium, ruthenium, iridium, osmium, rhodium, or a mixture of these metals, and/or a reactive element selected from zirconium (Zr), cerium (Ce), lanthanum (La), titanium (Ti), tantalum (Ta), hafnium (Hf), silicon (Si), and yttrium (Y), in particular a metal underlayer constituted of NiAlPt, or a metal underlayer of the MCrAlYPt type, where M is a metal selected from nickel, cobalt, iron, or a mixture of these metals, or else based on Pt. Finally, the bonding underlayer 13 may correspond to a coating of platinum diffused on its own and constituting a gamma-gamma prime matrix of nickel cobalt with platinum (Pt) in solution.

The ceramic layer 14 is constituted by yttrified zirconia having a molar content of yttrium oxide lying in the range 4% to 12% (partially stabilized zirconia). The stabilized zirconia 14 may also sometimes contain at least one oxide of an element selected from the group constituted by the rare earths, and preferably from the subgroup: Y (yttrium); Dy (dysprosium); Er (erbium); Eu (europium); Gd (gadolinium); Sm (samarium); Yb (ytterbium); or a combination of an oxide of Ta (tantalum) and at least one rare earth oxide; or with a combination of an oxide of Nb (niobium) and at least one rare earth oxide.

During fabrication, the bonding underlayer 13 is oxidized prior to the ceramic layer 14 being deposited, thereby giving rise to the presence of an intermediate layer of alumina 15 between the underlayer 13 and the ceramic layer 14.

FIG. 2 shows the various above-described layers, with a typical column structure of the ceramic layer 14 present at the surface.

After service, in which the part (e.g. a turbine blade) has been subjected to hundreds of cycles at high temperature (about 1100° C.), the morphology of the thermal barrier layer becomes modified as shown in FIG. 3: damage has appeared at the interface 16 between the underlayer 13 and the ceramic layer 14 that presents a rupture, this loss of bonding between the underlayer 13 and the ceramic layer 14 inevitably leading to delamination and flaking, i.e. to loss of the ceramic layer 14.

In the context of the present invention, the Applicant has analyzed various roughness profiles of the underlayer 13 as obtained after different surface treatments (prior art standard and optimized ranges in accordance with the present invention), and also the consequences in terms of flaking lifetime when the underlayer is coated in a ceramic layer 14.

Thus, the curve 20 in FIG. 4A corresponds to the roughness profile of the underlayer 13 after standard prior art sand blasting treatment prior to depositing the ceramic layer: there are numerous departures of the surface level about the mean profile with several “large” defects 21 presenting a departure between peaks (distance between the bottom of a furrow and the top of a ridge) of the order of 4 μm.

The curve 22 in FIG. 4B corresponds to the roughness profile of the underlayer 13 as it results from a first implementation of the method in accordance with the invention making use of a first physicochemical and/or mechanical process serving to modify the surface state prior to depositing the ceramic layer. This process is dry sand blasting for several minutes at a pressure of a few bars. As can be seen from curve 22, the departures of the surface level about the mean profile are smaller, and in general of the order of 1 μm, at most.

Curve 24 in FIG. 4C corresponds to the roughness profile of the underlayer 13 as it results from a second implementation of the method in accordance with the invention using a second physicochemical and/or mechanical process that serves to modify the surface state prior to depositing the ceramic layer. This process is mechanical polishing. As can be seen in FIG. 24, the departures of surface level around the mean profile are much smaller, and in general about 0.5 μm, at most.

By correlating the surface state of the underlayer 13 with the appearance of the rumpling phenomenon in the thermal barrier 11 comprising both the underlayer 13 and the ceramic layer 14, the Applicant has managed to establish various roughness criteria that need to be satisfied by the surface state of the underlayer 13 prior to depositing the ceramic layer in order to ensure that the rumpling phenomenon in the thermal barrier 11 comprising both the underlayer 13 and the ceramic layer 14 is very greatly delayed and/or completely inhibited.

When the presence of large amplitude defects is avoided, then the presence of crack initiation points and of privileged zones for harmful deformations, in particular the rumpling phenomenon, is avoided, in particular concerning the underlayer 13.

Thus, for example, the Applicant has established a first condition that consists in limiting the number of defects presenting a peak-to-peak difference that is lower than or equal to 2 μm and that is no more than 5 μm over any distance of 50 μm, the peak-to-peak difference being measured between the bottom of a valley and the top of a peak.

FIGS. 5A, 5B, and 5C show a prior art thermal barrier in which the surface state of the underlayer 13 does not satisfy the above first condition. FIG. 5C shows more than five defects presenting a peak-to-peak difference of more than 2 μm (specifically six “large defects” identified by arrows in FIG. 5B).

FIGS. 6A, 6B, and 6C show a thermal barrier obtained by the first implementation of the method in accordance with the invention using the first physicochemical and/or mechanical process and presenting a surface state for the underlayer 13 that satisfies said first condition: in FIG. 6C, there can be seen only two defects presenting a peak-to-peak difference of more than 2 μm (and thus fewer than five such defects).

FIGS. 7A, 7B, and 7C show a thermal barrier obtained by the second implementation of a method in accordance with the invention using the second physicochemical and/or mechanical process and presenting a surface state for the underlayer 13 that likewise satisfies said first condition: the surface state visible in FIG. 7A is even more regular and close to a straight line than in FIG. 6A. In FIG. 7C, there can be seen no defect presenting a peak-to-peak difference of more than 2 μm (so the number of such defects is less than five).

FIGS. 8A and 8B show respectively a prior art thermal barrier after service (1000 cycles at 1100° C.) in which the surface state of the underlayer 13 does not comply with the first condition, and a thermal barrier obtained by the second implementation of the method in accordance with the invention using the second physicochemical and/or mechanical process and presenting a surface state for the underlayer 13 that satisfies said first condition.

The flaking lifetimes were measured for prior art thermal barriers that do not comply with the surface state conditions for the underlayer 13 present under the ceramic layer, and for thermal barriers obtained by implementing the fabrication method of the invention: FIG. 8C shows the results for cycles of one hour at 1100° C. in air.

The first test (on the left in FIG. 8C) relates to a sample having a prior art thermal barrier (as shown in FIGS. 5A and 5B) and it withstood about 600 cycles.

The second test A (in the middle of FIG. 8C) relates to a sample having a thermal barrier similar to the above thermal barrier except for the fact that it was obtained by the first implementation of the method in accordance with the invention, using the first physicochemical and/or mechanical process (as shown in FIGS. 6A and 6B) so as to present a surface state for the underlayer 13 that complies with said first condition. This thermal barrier withstood about 800 cycles, giving a lifetime that is about 30% longer.

The third test B (on the right in FIG. 8C) relates to a sample having a thermal barrier similar to that of the first test except for the fact that it was obtained by the second implementation of the method in accordance with the invention using the second physicochemical and/or mechanical process (as shown in FIGS. 7A and 7B) so as to present a surface state for the underlayer 13 that complies with said first condition. This thermal barrier withstood about 1100 cycles, giving a lifetime that was increased by about 85%.

In order to avoid or delay the appearance of the rumpling phenomenon, the Applicant has shown the important role of the surface state of the underlayer 13 in the presence of the ceramic layer 14 in forming an assembly that constitutes a thermal barrier suitable for withstanding the rumpling phenomenon.

Thus, as can be seen in FIGS. 9A and 9B, which are micrographic views of the thermal barrier after service at different magnifications and obtained using the second implementation of the method in accordance with the invention using the second physicochemical and/or mechanical process.

In FIG. 9A there can be seen no rumpling damage has appeared at the interface 16 between the underlayer 13 and the ceramic layer 14.

In FIG. 9B, it can be seen that the alumina layer 15 remains dense, homogenous, and adherent, in spite of its considerable thickness.

FIGS. 10A and 10B show a thermal barrier obtained by the second implementation of the method in accordance with the invention using the second physicochemical process (polishing) so as to present a surface state for the underlayer 13 that satisfies said first condition.

In order to show the essential role of the ceramic layer 14, these FIGS. 10A and 10B at two different magnifications show the effect of having no ceramic layer 14 in the middle zone of FIG. 10A and in the right-hand portion of FIG. 10B: at the end of high temperature cycling, undulations appeared at the location of the underlayer 13 that was not coated in the ceramic layer 14, whereas such undulations are completely absent from the zones coated in the ceramic layer 14.

In this way, it can be understood that the conditions that need to be satisfied in order to achieve this object corresponding to combining the following two conditions:
the surface state of the underlayer 13 must present controlled roughness with a limited density of “large defects” per unit area; and
there must be the ceramic layer 14 on the underlayer 13 (directly on the underlayer 13 or with an interposed layer of alumina 15).

FIG. 11 shows the rumpling phenomenon for a zone of the underlayer 13 that is not coated in the ceramic layer 14: if there is initially a surface defect of size greater than the critical size, then after aging in service at high temperatures, the shape of the defect becomes more accentuated, thereby leading to undulation, which causes a rupture at the interface 16 between the underlayer 13 and the ceramic layer 14. In particular, with surface defects in the underlayer 13 of a size greater than the critical size:
such large-sized defects are to be found in the ceramic layer 14 (defects in the columns), thereby weakening the mechanical strength of the ceramic layer and its ability to withstand high temperatures;
such locations are privileged places for metallurgical phase transformations within the thermal barrier; and
such locations constitute zones that encourage the initiation of cracks.

Thus, it can be seen that the ceramic layer 14 is essential to avoid very rapid degradation of the thermal barrier 11, and that it serves simultaneously to stiffen the stack and to protect the underlayer 13, thereby inhibiting the rumpling phenomenon when the initial surface state of the underlayer 13 satisfies the conditions determined by the Applicant.

Because of this optimized surface state satisfying one or more of the conditions as determined by the Applicant, the following results are obtained:
an alumina layer 15 is grown that is dense, regular, and that adheres at all points to the underlayer 13, thereby providing complete physical protection for the underlayer 13 by means of the alumina layer 15 and the ceramic layer 14; and
a limit on the number of defects in the ceramic layer 14.

The examples described relate to nickel-based substrates coated in an underlayer 13 of NiAlPt type and covered in an alumina layer 15, itself surmounted by a ceramic layer 14 that is constituted by yttrified zirconia.

1-12. (canceled)

13. A fabrication method of fabricating a thermal barrier covering a superalloy metal substrate, the thermal barrier including at least an underlayer and a ceramic layer, the method comprising:
smoothing a surface state of the underlayer by at least one physicochemical and/or mechanical process prior to depositing the ceramic layer such that a number of defects presenting a peak-to-peak difference greater than or equal to 2 μm is at most five over any distance of 50 μm; and
then depositing the ceramic layer.

14. A fabrication method according to claim 13, wherein the physicochemical and/or mechanical process gives rise to a surface state of the underlayer such that a number of defects presenting an amplitude greater than 1 μm relative to the mean position of a top face of the underlayer is at most five over any distance of 50 μm.

15. A fabrication method according to claim 13, wherein the physicochemical and/or mechanical process gives rise to a surface state of the underlayer such that roughness Ra of the underlayer is in a range of 0.05 μM to 3 μm.

16. A fabrication method according to claim 13, wherein the physicochemical and/or mechanical process gives rise to a surface state of the underlayer such that roughness Ra of the underlayer is in a range of 0.05 μm to 1 μm.

17. A fabrication method according to claim 13, wherein the physicochemical and/or mechanical process gives rise to a surface state of the underlayer such that roughness Rz of the underlayer is less than 10 μm.

18. A fabrication method according to claim 13, wherein the physicochemical and/or mechanical process gives rise to a surface state of the underlayer such that at least one of the following criteria is satisfied:
0 μm<Rk<5 μm;
0 μm<Rvk<3 μm;
0 μm<Rpk<3 μm;
−1<Sk<1; and
1<Ek<10.

19. A fabrication method according to claim 13, wherein the physicochemical and/or mechanical process forms part of the group of dry sand blasting, wet sand blasting, mechanical polishing, electrolytic polishing, and tribofinishing.

20. A superalloy thermomechanical part including a thermal barrier obtained by the method according to claim 13.

21. A superalloy thermomechanical part according to claim 20, wherein the underlayer is a metal underlayer constituted by nickel aluminide optionally containing a metal selected from platinum, chromium, palladium, ruthenium, iridium, osmium, rhodium, or a mixture of these metals, and/or a reactive element selected from zirconium (Zr), cerium (Ce), lanthanum (La), titanium (Ti), tantalum (Ta), hafnium (Hf), silicon (Si), and yttrium (Y), or a metal underlayer of the MCrAlY type, where M is a metal selected from nickel, cobalt, iron, or a mixture of these metals, or based on Pt, or a metal underlayer corresponding to a coating of platinum diffused on its own and consisting in a gamma-gamma prime matrix of nickel cobalt with platinum (Pt) in solution.

22. A superalloy thermomechanical part according to claim 20, wherein the underlayer is constituted by an alloy suitable for forming a protective layer of alumina by oxidation.

23. A superalloy thermomechanical part according to claim 20, wherein the ceramic layer is based on yttrified zirconia presenting a molar content of yttrium oxide lying in a range of 4% to 12%.

24. A superalloy thermomechanical part according to claim 20, wherein the part is a combustion chamber, a turbine blade, a turbine distributor, or any thermomechanical part suitable for being coated in a thermal barrier system.
